(19) United States
(12) Patent Application Publication
(10) Pub. No.: US 2008/0060450 A1
(43) Pub. Date: Mar. 13, 2008

(54) Sensor Device and Method for Detecting an External Impact Load on a Vehicle

(76) Inventors: Michael Bischoff, Rottenberg (DE); Marc Diemer, Oberursel (DE); Matthew Scott, Haibach (DE); Franz Hoiss, Bernried (DE); Michael Fiedler, Biebergemund (DE)

Correspondence Address: AKERMAN SENTERFITT, P.O. BOX 3188, WEST PALM BEACH, FL, 33402-3188, US

(21) Appl. No.: 10/529,155

(22) PCT Filed: Aug. 29, 2003
(86) PCT No.: PCT/EP03/09592

§ 371 Date: Oct. 26, 2007

(30) Foreign Application Priority Data
Sep. 25, 2002 (DE) 102 44 528.1

(51) Int. Cl. G01L 1/24

(52) U.S. Cl. 73/862.041

(57) ABSTRACT

The invention relates to a sensor device and a method for detecting an external impact load on a vehicle (12), especially in the event of a collision with a pedestrian. Said sensor device comprises a sensor line (14) which reacts to a mechanical deformation, a carrier body (16) for receiving the sensor line (14), and a measuring unit (20) which co-operates with the sensor line (14) and is used to provide an impact signal. Said carrier body (16) has a deformation structure (18) engaging with the sensor line (14), for varying the transmission of pressure force in certain sections.

### BACKGROUND OF THE INVENTION

1. Field of the Invention

The invention concerns a sensor device for detecting an external impact load on a vehicle, in particular the impact of a pedestrian, as well as a corresponding process.

2. Related Art of the Invention

The advanced requirements in personal protection in motor vehicle traffic makes it necessary to detect critical situations as rapidly and reliably as possible, in order to undertake appropriate emergency or protective precautions.

In particular in the case of the collision of a motor vehicle with a pedestrian the impact load should be recognized, in order to initiate any possible injury minimizing counter measures. It is however problematic, to cover the large surface area in which an impact may occur with individual sensors, wherein the different mounting locations further complicate the absolute evaluation of an accident situation.

### SUMMARY OF THE INVENTION

Beginning therewith, it is the task of the invention to avoid the disadvantages in the state of the art and to improve the sensor device and the corresponding sensor process of the above described state of the art in such a manner that a selective and reliable impact recognition or, as the case may be, collision sensing is accomplished, particularly in a design suitable for economical mass production.

For the solution of this task the combination of characterizing features respectively set forth in the independent patent claims is proposed. Advantageous embodiments and further developments of the invention can be seen from the dependent claims.

Accordingly, it is proposed in accordance with the invention that the sensor device for detection of an external impact load on a vehicle, in particular in the case of a pedestrian impact, includes a sensor device responsive to mechanical deformation, a carrier body receiving the sensor device and a measuring unit cooperating with the sensor device for providing an impact signal, wherein the carrier body has a deformation structure engaging with the sensor line for varying pressure force transmission in certain sections. By the use of a sensor line it becomes possible to sense along a large outer surface area of the vehicle, without necessitating a large number of individual sensors. By the adaptation of the force transmission via a deformation structure it can be taken into consideration that the mounting conditions and therewith the force transmission characteristics vary over the geometry of the vehicle.

Preferably, due to the deformation structure, the signal transmission characteristic in the sensor line is influenced in the case of an impact by mechanical deformation.

For an evaluation of the signal level it is advantageous when the pressure force transmission is adaptable to the yield strength of the surrounding vehicle parts by adaptation means provided along the length of the sensor line.

In accordance with a particularly preferred embodiment the pressure force transmission is so adapted, that the impact signal, for a predetermined given impact load, remains the same independent of the location of the impact. In this manner it is possible to evaluate the impact strength independent of location with low error rate.

In order to adapt the force transmission, it is advantageous when the deformation structure includes a number of force transmission elements as adaptation means distributed along the sensor line in uneven separation from each other.

For the local modification of the sensitivity of the sensor it is advantageous when the carrier body exhibits an irregularly changeable bending stiffness along the sensor line due to changes in cross section or in the material thickness or due to apertures or the like as the adaptation means.

One preferred embodiment envisions that the carrier body includes an elastically deformable spacer of which the elasticity varies along the length of the sensor line. This can be realized thereby, that at least one longitudinal bar is provided running along the sensor line and bendable or deformable upon transverse loading, wherein the longitudinal bar exhibits a variable wall thickness or wall weakness for adaptation of its transverse stiffness or rigidity.

For producing the signal it is advantageous when the deformation structure influences the sensor line under local bend loads of the deformation structure.

For a locally resolved sensing it is advantageous when multiple sensor lines are provided next to each other. In an advantageous embodiment it is provided that multiple sensor lines have active segments in engagement with the deformation structure and blind segments not in engagement. In order to simplify the local resolution or sensitivity it is advantageous when the length of the segments vary along the line. According to a further improvement, the length of the active and blind segments in a row of sensor lines decreases in a fixed ratio.

The deformation structure preferably includes two comb-like deformation bodies, wherein the sensor line preferably runs linearly between the deformation bodies which upon impact engage within each other.

With regard to manufacturing and measurement techniques it is advantageous when the sensor line is comprised of at least one optical fiber. Other sensors are also conceivable, for example piezoelectric, pneumatic or hydraulic type sensor lines or, as the case may be, cables.

For coupling light in and out at an interface, it is preferred when each sensor line includes two conductor segments running next to each other and connected with each into a continuous line for example via a loop (end loop).

With regard to the process, the task discussed above is solved in that an impact signal is produced by the sensor line in response to mechanical deformation, wherein the transmission of pressure force on the sensor line is locally varied by the deformation structure, so that the measurement signal for a given impact load remains the same independent of the impact location.

A further advantageous measure is comprised therein, that light is introduced into an optical fiber of a sensor device and is influenced by changes in the bend radius of the light transmission in the optical fibers, wherein a signal change of the light signal derived from the optical fiber is evaluated as an impact signal.

### BRIEF DESCRIPTION OF THE DRAWINGS

In the following the invention will be described in greater detail on the basis of the illustrated embodiment shown in schematic manner in the figures. There is shown

FIG. 1 a motor vehicle with a sensor device integrated into the bumper for detection of an impact with a pedestrian, in perspective representation;

FIG. 2 a vertical cross-section segment of FIG. 1;

FIG. 3 the sensor device in cut-away longitudinal section;

FIG. 4 a section along section line 4-4 in FIG. 3;

FIG. 5 a signal trace of an impact signal detected by the sensor device;

FIGS. 6 & 7 further embodiments of a carrier body for the sensor device in a representation corresponding to FIG. 4; and

FIG. 8 a sensor device with a number of sensor lines in a schematic representation.

### DETAILED DESCRIPTION OF THE INVENTION

The sensor device 10 shown in the figures can be employed in general for detection of an external impact load on a vehicle 12 and serves in particular for detection of a pedestrian impact. The sensor device includes for this purpose a sensor line 14, a longitudinally extending carrier body 16 for receiving the sensor line, a deformation structure 18 contained in the carrier body and a measuring unit 20 cooperating with the sensor line for providing a measurement signal or, as the case may be, impact signal.

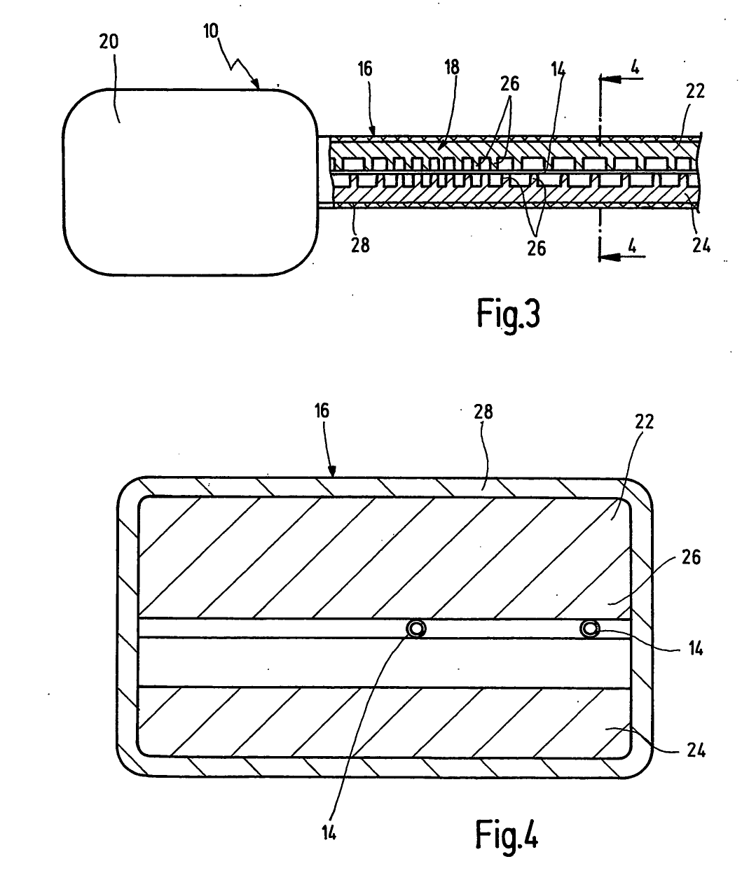

As can be seen particularly from FIGS. 3 and 4, the deformation structure 24 includes two comb-like partial pieces 22, 24 which are limitedly movable relative to each other upon application of an external force thereby causing local bending of the linear sensor line 14. The bending exposure is actualized by force transmission elements 26 engaging sideways on the sensor line 14, which are provided distributed irregularly along the length of the sensor line. By a corresponding variation of the spacing relative to each other of these adaptation means, the force transmission can be locally adapted to the solidity or yield strength of the surrounding vehicle part, so that in the case of a given external force the degree of deformation remains the same independent of where the point of impact is located.

The sensor line 14 is comprised of a light guide or, as the case may be, an optical fiber cable, which includes two parallel to each other running fiber segments connected at an end, not shown in FIG. 3, for example by a loop so as to be continuous. The light entry and light emission ends are coupled with the opto-electronic measuring unit 20. Evaluation software can also be loaded into the measuring unit 20, so that no separate control device is necessary. The total device is sealed cast into a receptacle casing 28 and can thus be simply integrated into the vehicle 12. It is also possible that the sensor line 14 includes additional not shown optical fibers, which are employed for example for reference measurement.

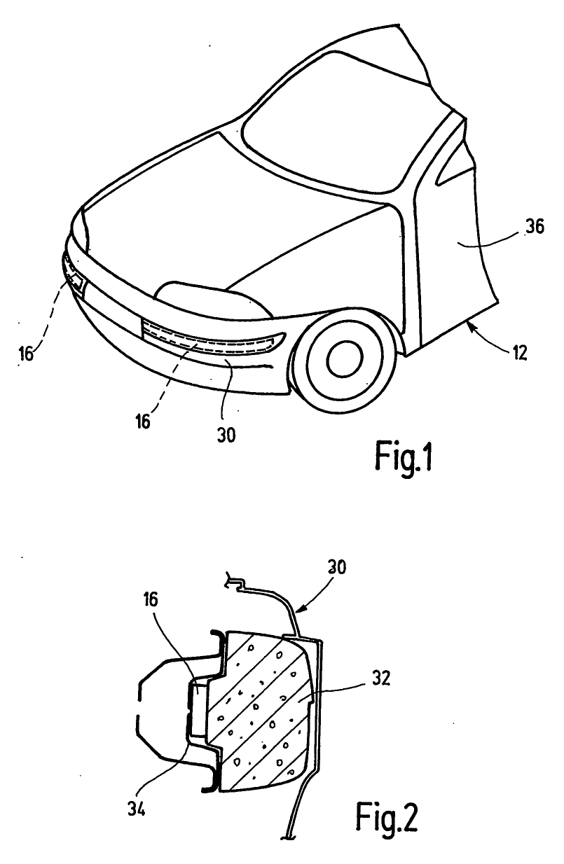

In the installation arrangement shown in FIG. 1 and 2 the sensor line 14 runs along the front bumper 30 of the vehicle 12, wherein the carrier body 16 is enclosed between a front absorber body 32 and a rear transverse carrier 34. It is also conceivable to install the sensor device 10 in a hollow space of a side door 36, in order to detect a side impact. Another application of the device could comprise detecting a pinning or clamping (of, e.g., a limb) in the area of an electrically operated side window or in the area of the retractable or sliding roof.

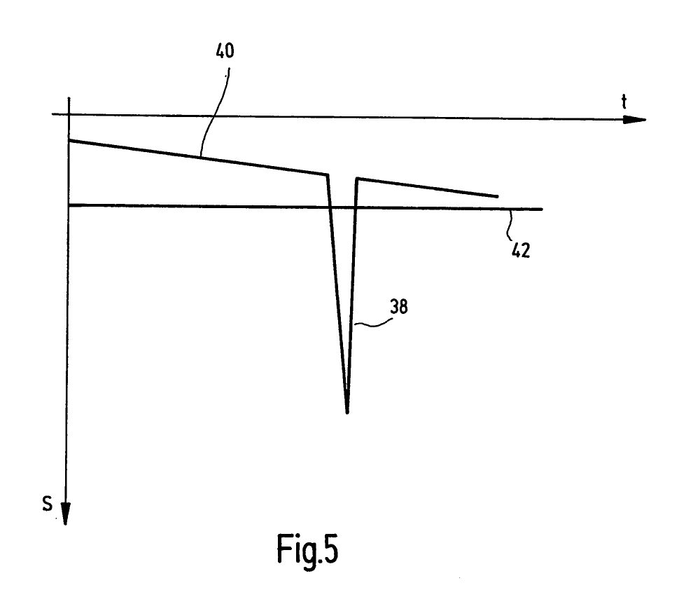

Upon application of external pressure or, as the case may be, the action of an impact, the optical fiber 14 is bent at the respective impact location in corrugated manner by the transmission elements 26 of the deformation structure 18, so that the sensing light passing therethrough changes in intensity or, as the case may be, experiences and attenuation. As shown in FIG. 5, this results, in correspondence with the size of the instantaneous deformation, in a (negative) signal peak 38 in the signal trace. The amplitude thereof serves as the gage or measure of the impact strength. Thereby, as a result of the design of the deformation structure 18 in adaptation to the environment of installation, an absolute evaluation is possible.

It is possible in all embodiments to use the signal trace 40 outside of the signal peak 38 for the continuous self-diagnosis of the sensor device 10. In this long time range a system-dependent dampening component occurs, which causes a drift shown in exaggerated form in FIG. 5, depending upon temperature, preload and other assembly or configuration perimeters. While the dynamic signals 38 occur in a fraction of a second, the time scale of the signal drift is substantially higher than this. The slowly changing signal level is compared with a predetermined threshold value 42, which if exceeded is diagnosed as a sensor malfunction. Therein it is advantageous when the threshold value 42 is so selected, depending upon the maximum dynamic signal to be detected, that it is always possible fundamentally to detect the full peak amplitude. It is not necessary that the threshold value be maintained constant therein, but rather it can be updated for example depending upon operating and environment parameters.

In an alternative embodiment it is envisioned that the carrier body directly or intimately surrounds the optical fiber line or, as the case may be, light guide 14, and upon mechanical deformation influences the refractive index and therewith the transmission or as the case may be attenuation of the light signal in the optical fiber line.

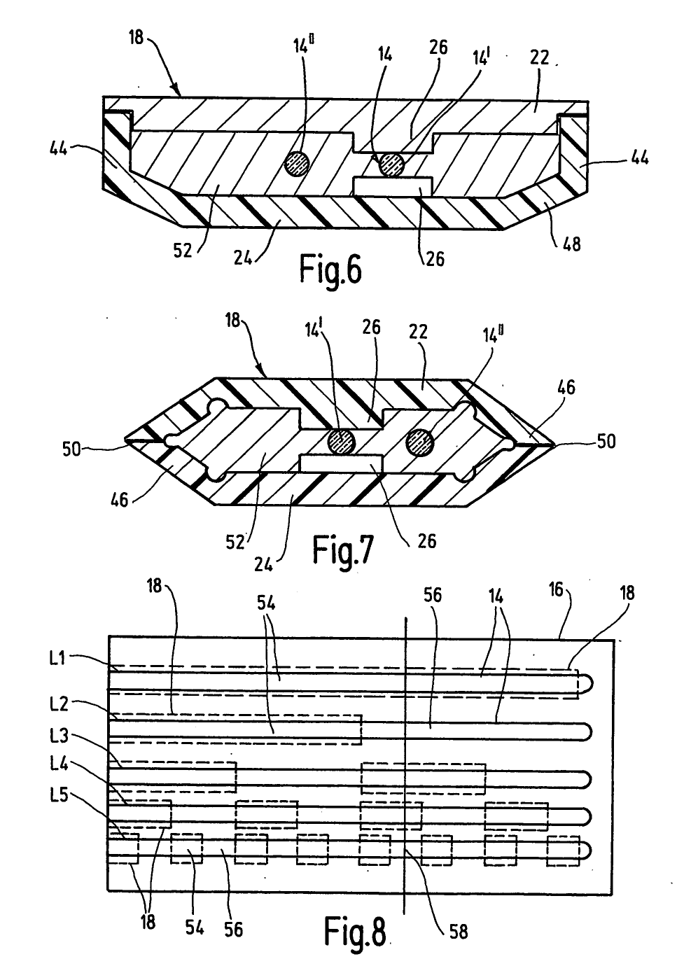

The illustrated embodiments shown in FIGS. 6 and 7 differ from the embodiment according to FIG. 3 and 4 in that the force transmission elements 26 engaging comb-like in each other are provided spaced evenly apart, while the sideways connecting walls 44, 46 act on the deformation bodies 22, 24 as elastic spacers with a stiffness that is modified where required. In this manner the force transmission can be adjusted variably along the light guide 14. According to FIG. 6 the beveled wall 48 acts herein as a leaf spring, in order to adapt to the area being measured. In FIG. 7 for this purpose the sidewalls 46 connected to the adhesion location 50 are sideways elastically bendable. In both cases only one guide segment 14′ is subjected to the deformation, in comparison to which the segment 14″ led back via a loop remains undeformed, for example in a foamed grout mass 52.

For localized detection multiple parallel running light cables 14 can be provided as conductor or guide row (L1-L5) as seen in FIG. 8, wherein the elements of the row are sectionally in engagement with the deformation structure 18 forming work segments 54, and therefrom non-sensitive blind segments, for example covered by a not shown covering. In order to make the position recognition more precise, the active segments of respectively two row elements (L1, L2; L2, L3 . . . ) are in a length ratio of 2:1. Accordingly, in the distribution or arrangement shown in FIG. 8 the force influence can be recognized for example in the area of the longitudinal segment 58 by a simultaneous signal from lines L1, L3 and L4 with the absence of signals in the remaining lines.

For detecting a pedestrian impact the sensor line or as the case may be light guide or conductor bundle should run as far forward on the vehicle as possible, in order to detect the impact as early as possible. Besides this, a low force level must be detectable, in order to be able to distinguish a collision with a pedestrian in comparison to a hard impact with a solid object. The sensor device can also be employed in order to relay the early impact detection signal to safety devices such as air bags or crash boxes. In particular, it is also possible to so adjust or program the crash box that they are adjusted to be soft in the case of a pedestrian impact and harder in a different type of impact. Thereby a soft setting should be selected as preset, in order to give priority to protecting the pedestrian.

1. A sensor device for detecting an external impact load on a vehicle (12), in particular in the case of a pedestrian impact, with at least one sensor line (14) responsive to a mechanical deformation, a carrier body (16) receiving the sensor line (14), and a measuring unit (20) cooperating with the sensor line (14) for providing an impact signal, wherein the carrier body (16) includes a deformation structure (18) in engagement with the sensor line (14) for segment-wise variable pressure force transmission.

2. The sensor device according to claim 1, wherein the deformation structure (18) influences the signal transmission in the sensor line (14) in the case of an impact.

3. The sensor device according to claim 1, wherein the pressure force transmission is adaptable to the impact resistance of the surrounding vehicle part (32) via adaptation means (26; 44, 46) provided along the length of the sensor line (14).

4. The sensor device according to claim 1, wherein the pressure force transmission is so adapted, that the impact signal in the case of a predetermined impact load remains constant independent of the point of impact.

5. The sensor device according to claim 1, wherein the deformation structure (18) includes a number of force transmission elements (26) distributed along the sensor line (14) in uneven separation from each other.

6. The sensor device according to claim 1, wherein the carrier body (16) exhibits an irregular changeable bending resistance or stiffness along the sensor line (14) as a result of changes in the cross section or in the material density or as a result of breakthroughs or recesses or the like as adaptation means.

7. The sensor device according to claim 1, wherein the carrier body (16) includes an elastically deformable spacer (14, 16) with elasticity varying along the sensor line (14).

8. The sensor device according to claim 1, wherein the carrier body (16) includes at least one longitudinal bar (44, 46), bendable or buckling under transverse load, running along the sensor line (14).

9. The sensor device according to claim 8, wherein the longitudinal bar (44, 46) includes a variable wall thickening or wall weakening for adaptation of its transverse stiffness.

10. The sensor device according to claim 1, wherein the deformation structure (18) acts upon the sensor line (14) upon exposure to local bending forces.

11. The sensor device according to claim 1, wherein multiple sensor lines (14) are provided next to each other.

12. The sensor device according to claim 1, wherein multiple sensor lines (L1-L5) include active segments (54) in engagement with the deformation structure (18) and blind segments (56) not in engagement.

13. The sensor device according to claim 12, wherein the length of the segments (54, 56) varies for different sensor lines (14).

14. The sensor device according to claim 12, wherein the length of the active and blind segments (54, 56) for each row (L1-L5) of sensor lines (14) decreases at a fixed ratio.

15. The sensor device according to claim 1, wherein the deformation structure (18) includes two comb-like deformation bodies (22, 24), and that the sensor line (14) runs between the deformation bodies (22, 24) which engage in each other upon impact.

16. The sensor device according to claim 1, wherein the sensor line includes at least one optical fiber (14).

17. The sensor device according to claim 1, wherein the sensor line (14) includes two conductor or guide segments (14′, 14″) running side by side and continuously connected, preferably via a loop.

18. A process for detecting an external impact load on a vehicle (12), in particular in the case of a pedestrian impact,
wherein an impact signal is produced by a sensor line (14) responsive to a mechanical deformation,
wherein the force transmission on the sensor line (14) is locally varied by a deformation structure (18), so that the impact signal in the case of a predetermined impact load remains the same independent of the impact point.

19. The process according to claim 18, wherein light is introduced into an optical fiber (14) of a sensor device (10) and that the light transmissivity in the optical fibers (14) is influenced by changes in the radius of bends bend, and that a signal change of the light signal derived from the optical fiber is evaluated as impact signal.
